(19) United States
(12) Patent Application Publication
(10) Pub. No.: US 2010/0011906 A1
(43) Pub. Date: Jan. 21, 2010

(54) Adjustment Mechanism for Strokeadjustable Reciprocating Fluid Machine

(76) Inventor: Per Olav Haughom, Tonstad (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/520,076

(22) PCT Filed: Dec. 14, 2007
(86) PCT No.: PCT/NO2007/000442

§ 371 Date: Sep. 18, 2009

(30) Foreign Application Priority Data
Dec. 22, 2006 (NO) 20066086

(51) Int. Cl. F16H 21/20

(52) U.S. Cl. 74/837

(57) ABSTRACT

An adjustment mechanism for a stroke-adjustable reciprocating fluid machine comprising a crank shaft which is rotatable about a rotational axis, and a rotatable eccentric crank eccentrically supported about the crank shaft in a bearing, the crank having a crank centre, and the crank centre being adjustable relative to the rotational axis between a largest and a smallest radial distance thereto, and an adjustment motor connected to the drive of the fluid machine also being connected to the crank via a third angular gear which cooperates with a fourth angular gear, the fourth angular gear being connected to an adjustment output axle having its centre on the rotational axis and being connected to the crank by means of an adjustment sleeve, the crank shaft being connected to the main drive shaft of the fluid machine via a first angular gear which cooperates with a second angular gear.

This invention relates to an adjustment mechanism for a stroke-adjustable reciprocating fluid machine. More particularly, it relates to an adjustment mechanism for a stroke-adjustable reciprocating fluid machine comprising a crank shaft rotatable about a rotational axis and a rotatable eccentric crank eccentrically supported about the crank shaft in a bearing, the crank having a crank centre. The crank centre is adjustable relative to the rotational axis between a largest and a smallest radial distance thereto. The crank shaft is connected to the main drive shaft of the fluid machine via a first angular gear cooperating with a second angular gear, an adjustment motor connected to the drive of the fluid machine also being connected to the crank via a third angular gear cooperating with a fourth angular gear. The fourth angular gear is connected to an adjustment output axle which has its centre on the rotational axis and which is connected to the crank by means of an adjustment sleeve.

By a reciprocating fluid machine is meant, in this context, pumps and motors. The term “reciprocating fluid machine” is applied to include diaphragm pumps as well as piston pumps and engines. In what follows, reference is made to pumps as the adjustment mechanism seems to be the most relevant to pumps.

Relatively often there is a need for being able to adjust the fluid flow through a pump even though the pump is driven at a constant speed of rotation, for example by means of an electric cage induction motor. When it comes to dosing a fluid, it is also of importance to be able to preset the pump to a given fluid flow for a given speed of rotation.

The NO 311191 document deals with an in-line pump, in which the fluid flow is adjustable between zero and a maximum value. The crank of the pump, which is eccentric relative to its support on a crank shaft, is rotatable about the crank shaft, the support of the crank on the crank shaft also being eccentric relative to the rotational axis of the crank shaft.

The crank may, if the support of the crank on the crank shaft is just as much off centre to the crank as it is to the crank shaft, be rotated relative to the crank shaft between a first position, in which the crank centre of the crank coincides with the rotational axis of the crank shaft, and a second position, in which the crank has been rotated 180° about the crank shaft, the crank centre thereby being at a maximum distance from the rotational axis of the crank shaft.

An in-line pump allows relatively little flexibility in its configuration and may thus be relatively space-demanding.

The invention has for its object to remedy or reduce at least one of the drawbacks of the prior art.

The object is achieved in accordance with the invention through the features which are specified in the description below and in the claims that follow.

An adjustment mechanism for a stroke-adjustable reciprocating fluid machine comprising a crank shaft rotatable about a rotational axis and a rotatable eccentric crank eccentrically supported about the crank shaft in a bearing, the crank having a crank centre, and the crank centre being adjustable relative to the rotational axis between a largest and a smallest radial distance, is characterized according to the invention by an adjustment motor which is connected to the drive of the fluid machine, being connected to the crank via a third angular gear which cooperates with a fourth angular gear, the fourth angular gear being connected to an adjustment output axle which has its centre on the rotational axis, and which is connected to the crank by means of an adjustment sleeve. The crank shaft is connected to the main drive shaft of the fluid machine by way of a first angular gear which cooperates with a second angular gear.

The adjustment sleeve is provided with a gear rim complementarily matching a toothed ring on the crank.

The toothed ring is concentric with the bearing. The radial largest distance from the rotational axis to a point on the toothed ring equals the sum of the eccentric distance of the bearing and the radius of the toothed ring. This sum is constant and causes the toothed ring to be in mesh with the gear rim independently of the prevailing rotational angle between the crank and the crank shaft.

The gear rim is normally provided with more teeth than the toothed ring.

The housing of the adjustment motor is connected to the drive of the piston engine when the drive shaft of the adjustment motor is connected to the adjustment mechanism. Alternatively, the housing of the adjustment motor is connected to the adjustment mechanism when the drive shaft of the adjustment motor is connected to the drive of the piston engine.

If the gear ratio between the adjustment motor and crank shaft is equal to the gear ratio of the adjustment motor and the adjustment output axle of the adjustment mechanism, the adjustment motor will keep the crank at rest relative to the crank shaft when the drive shaft of the adjustment motor is at rest relative to the housing of the adjustment motor.

Independently of the relative gear ratios between the drive and adjustment mechanism, the adjustment motor is arranged to adjust the crank relative to the crank shaft, at least between a largest and a smallest radial distance as the drive shaft of the adjustment motor is rotated relative to the housing of the adjustment motor.

If the relative gear ratios between the drive and adjustment mechanism are different, an adjustment will take place even if the drive shaft of the adjustment motor is at rest relative to the housing of the adjustment motor.

As the housing of the adjustment motor is normally rotating when the pump is in operation, it is necessary for the adjustment motor to be supplied with driving fluid via a swivel connection if the adjustment motor is formed by a fluid motor.

If the adjustment motor is formed by an electromotor, the adjustment motor may be supplied with power via a slip-ring or via a non-contact transmission. NO 320439 describes a non-contact energy transmission which may be appropriate.

A device in accordance with the invention provides relatively great flexibility in its configuration and can, thereby, be adjusted to the prevailing space conditions, while at the same time, during operation, and continuously if desirable, the pump may be adjusted within its delivery range between its maximum and its minimum flow rates. Thereby, the invention solves a long-felt problem in a relatively simple and reliable manner. The device is well suited for pumps with one or more cylinders or diaphragms.

In what follows, there is described an example of a preferred embodiment which is visualized in the accompanying drawings, in which:

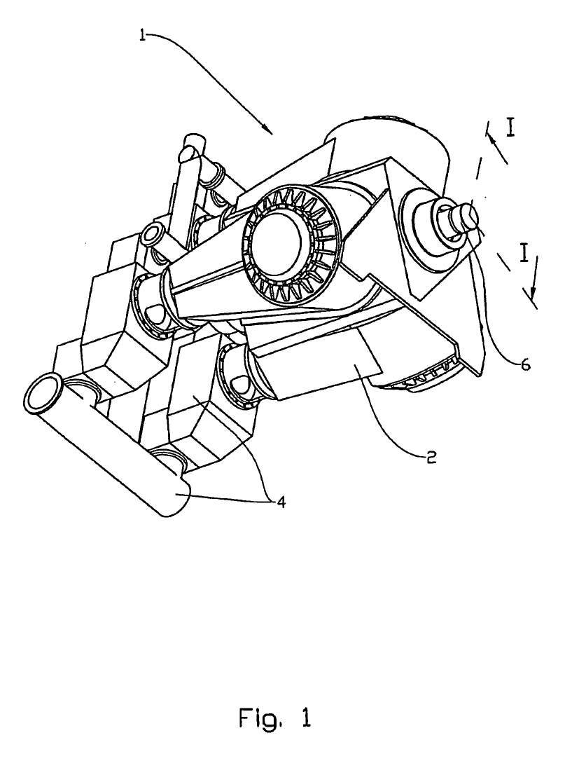

FIG. 1 shows in perspective a triple diaphragm pump according to the invention;

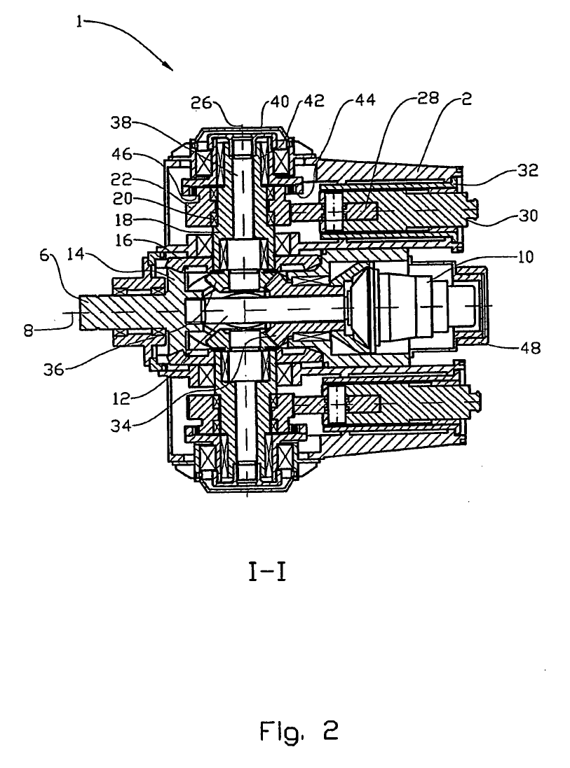

FIG. 2 shows the section I-I of FIG. 1, but the “fluid part” of the pump has been removed;

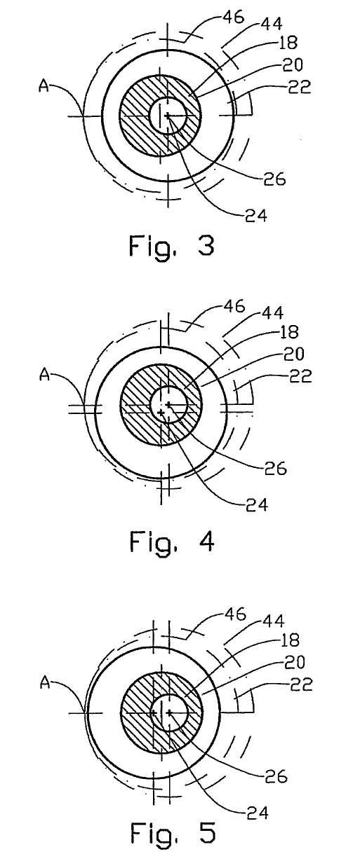

FIG. 3 shows schematically an end view of the crank and crank shaft of the pump, the crank centre of the crank being concentric with the rotational axis of the crank shaft;

FIG. 4 shows the same as FIG. 3, but after the crank has been rotated 90° about the crank shaft; and

FIG. 5 shows the same as FIG. 3, but after the crank has been rotated 180° about the crank shaft.

In the drawings the reference numeral 1 denotes a triple diaphragm pump comprising a pump housing 2, necessary fluid channels 4 and a main drive shaft 6 which is connected, in operation, to a driving motor not shown.

The components and mode of operation of the diaphragm pump 1 are described below. The many bearings are not described in particular but are indicated in the drawings. Furthermore, reference is made to only one set of components, as it is understood that other corresponding sets of components have corresponding functions.

The diaphragm pump 1 is built up around a pump axis 8. The pump axis 8 coincides with the centre axis of the main drive shaft 6. An adjustment motor 10 which is connected via its drive shaft 12 to the main drive shaft 6, is also on the pump axis 8, the drive shaft 12 of the adjustment motor 10 co-rotating with the main drive shaft 6.

At its end portion facing into the diaphragm pump 1, the main drive shaft 6 is provided with a first angular gear 14 which cooperates with a second angular gear 16. The second angular gear 16 is connected to a tubular crank shaft 18. In this preferred exemplary embodiment, the crank shaft 18 projects at right angles from the pump axis 8, but may take any appropriate angle.

Externally, the crank shaft 18 is assigned an eccentric bearing 20 for a crank 22. The outside course of the crank 22 is eccentric also relative to the bearing 20.

In this preferred exemplary embodiment the bearing 20 is just as eccentric relative to the crank shaft as the bearing 20 is eccentric relative to the crank 22, see FIG. 3, in which the crank 22 has been rotated to a position in which the crank centre 24 of the crank 22 coincides with the rotational axis 26 of the crank shaft 18.

In FIG. 5 the crank has been rotated 180° relative to the crank shaft 18, whereby the radial distance between the rotational axis 26 and crank centre 24 is the largest. FIG. 4 shows the crank 22 in an intermediate position relative to the crank shaft 18.

A running pulley 28 bears on the crank 22 and is supported in a plunger 30 which is movably supported in a guide 32 in the pump housing 2.

The adjustment motor 10 is attached to a third angular gear 34 surrounding the drive shaft 12 and meshing with a fourth angular gear 36. The fourth angular gear 36 is connected to the inner end portion of an adjustment output axle 38 extending through and concentric with the tubular crank shaft 18, the adjustment output axle 38 being provided, at its opposite end portion, with a rotary flange 40.

The rotary flange 40 engages an adjustment sleeve 42. The adjustment sleeve 42 is provided with an internal gear rim 44 projecting in over a complementarily matching toothed ring 46 on the crank 22.

The toothed ring 46 of the crank 22 is concentric with the bearing 20. The radial, largest distance from the rotational axis 26 to a point A on the toothed ring 46 equals the sum of the eccentric distance of the bearing 20 and the radius of the tooted ring 46. This sum is constant and causes the toothed ring 46 to mesh with the gear rim 44 regardless of the prevailing rotational angle between the crank 22 and the crank shaft 18, see FIGS. 3-5.

The adjustment motor 10, which is a fluid motor, is supplied with driving fluid via a swivel connection 48 and pipelines not shown.

The main drive shaft 6, first angular gear 14, second angular gear 16, crank shaft 18 and crank 22 constitute the drive 6, 14, 18, 22 of the diaphragm pump 1, whereas the third angular gear 34, fourth angular gear 36, adjustment output axle 38, rotary flange 40, adjustment sleeve 42 and toothed ring 46 of the crank constitute the adjustment mechanism 34, 36, 38, 40, 42, 46 of the diaphragm pump 1.

When the flow rate through the diaphragm pump 1 is to be adjusted, pressurized fluid is supplied via the swivel connection 48, so that the drive shaft 12 of the adjustment motor 10 is rotated relative to the rest of the adjustment motor 10. Thereby, the adjustment output axle 38 is brought to rotate at a different speed relative to the crank shaft 18. By the fact that the adjustment output axle 38 carries the adjustment sleeve 42 engaging the crank 22, the crank 22 is also brought to rotate relative to the crank shaft 18 and, thereby, to readjust the radial distance of the crank centre 24 of the crank 22 to the rotational axis 26 of the crank shaft 18, see FIGS. 3 to 5.

1. An adjustment mechanism for a stroke-adjustable reciprocating fluid machine comprising a crank shaft which is rotatable about a rotational axis, and a rotatable eccentric crank eccentrically supported about the crank shaft in a bearing, the crank having a crank centre, and the crank centre being adjustable relative to the rotational axis between a largest and a smallest radial distance thereto, wherein an adjustment motor which is connected to the drive of the fluid machine is also connected to the crank via a third angular gear which cooperates with a fourth angular gear, the fourth angular gear being connected to an adjustment output axle having its centre on the rotational axis and being connected to the crank by means of an adjustment sleeve, the crank shaft being connected to the main drive shaft of the fluid machine via a first angular gear which cooperates with a second angular gear.

2. The device in accordance with claim 1, wherein the adjustment sleeve is provided with a gear rim complementarily matching a toothed ring on the crank.

3. The device in accordance with claim 2, wherein the toothed ring is concentric with the bearing.

4. The device in accordance with claim 2, wherein the gear rim has more teeth than the toothed ring.

5. The device in accordance with claim 1, wherein the housing of the adjustment motor is connected to the drive of the fluid machine, and the drive shaft of the adjustment motor is connected to the adjustment mechanism.

6. The device in accordance with claim 1, wherein the housing of the adjustment motor is connected to the adjustment mechanism, and the drive shaft of the adjustment motor is connected to the drive of the fluid machine.

7. The device in accordance with claim 1, wherein the adjustment motor is arranged to keep the crank at rest relative to the crank shaft when the drive shaft of the adjustment motor is at rest relative to the housing of the adjustment motor.

8. The device in accordance with claim 1, wherein the adjustment motor is arranged to adjust the crank centre of the crank relative to the rotational axis of the crank shaft at least between a largest and a smallest radial distance when the drive shaft of the adjustment motor is rotated relative to the housing of the adjustment motor.

9. The device in accordance with claim 1, wherein the adjustment motor is supplied with driving fluid via a swivel connection.

10. The device in accordance with claim 1, wherein the adjustment motor is supplied with power via a slip ring.

11. The device in accordance with claim 1, wherein the adjustment motor is supplied with power via a non-contact connection.
